(19) United States
(12) Patent Application Publication
(10) Pub. No.: US 2026/0214585 A1
(43) Pub. Date: Jul. 23, 2026

(54) A Primary Wireless Communications Device, a Secondary Wireless Communications Device and Methods for Synchronization of Device-to-Device Wireless Communication

(71) Applicant: Telefonaktiebolaget LM Ericsson (publ), Stockholm (SE)

(72) Inventors: Henrik Sjöland, Lund (SE); Gang Zou, Lund (SE)

(21) Appl. No.: 19/137,426

(22) PCT Filed: Dec. 21, 2022
(86) PCT No.: PCT/EP2022/087333

§ 371 Date: Jun. 10, 2025

(51) Int. Cl. H04W 52/02; H04W 56/00; H04W 72/30; H04W 76/14

(52) U.S. Cl. CPC H04W 52/0245; H04W 56/001; H04W 72/30; H04W 76/14

(57) ABSTRACT

A method, performed by a primary wireless communications device, for synchronization of Device-to-Device, D2D, wireless communication between the primary wireless communications device and a secondary wireless communications device, the method comprises: broadcasting (703), on a Device-to-Device, D2D, wireless communications channel, a single-tone synchronization signal for synchronization of the secondary wireless communications device to the primary wireless communications device, wherein broadcasting the single-tone synchronization signal comprises modulating the single-tone synchronization signal with a modulating data sequence.

### TECHNICAL FIELD

The embodiments herein relate to a primary wireless communications device, a secondary wireless communications device and methods for synchronization of Device-to-Device wireless communication. A corresponding computer program and a computer program carrier are also disclosed.

### BACKGROUND

In a typical wireless communication network, wireless devices, also known as wireless communication devices, mobile stations, stations (STA) and/or User Equipments (UE), communicate via a Local Area Network such as a Wi-Fi network or a Radio Access Network (RAN) to one or more core networks (CN). The RAN covers a geographical area which is divided into service areas or cell areas. Each service area or cell area may provide radio coverage via a beam or a beam group. Each service area or cell area is typically served by a radio access node such as a radio access node e.g., a Wi-Fi access point or a radio base station (RBS), which in some networks may also be denoted, for example, a NodeB, eNodeB (eNB), or gNB as denoted in 5G. A service area or cell area is a geographical area where radio coverage is provided by the radio access node. The radio access node communicates over an air interface operating on radio frequencies with the wireless device within range of the radio access node.

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio access nodes are directly connected to the EPC core network rather than to Radio Network Controllers (RNCs) used in 3G networks. In general, in E-UTRAN/LTE the functions of a 3G RNC are distributed between the radio access nodes, e.g. eNodeBs in LTE, and the core network. As such, the RAN of an EPS has an essentially “flat” architecture comprising radio access nodes connected directly to one or more core networks, i.e. they are not connected to RNCs. To compensate for that, the E-UTRAN specification defines a direct interface between the radio access nodes, this interface being denoted the X2 interface.

### Wireless Communication Systems in 3GPP

FIG. 1 illustrates a simplified wireless communication system. Consider the simplified wireless communication system in FIG. 1, with a UE 12, which communicates with one or multiple access nodes 103-104, which in turn is connected to a network node 106. The access nodes 103-104 are part of a radio access network 10.

For wireless communication systems pursuant to 3GPP Evolved Packet System, (EPS), also referred to as Long Term Evolution, LTE, or 4G, standard specifications, such as specified in 3GPP TS 36.300 and related specifications, the access nodes 103-104 corresponds typically to Evolved NodeBs (eNBs) and the network node 106 corresponds typically to either a Mobility Management Entity (MME) and/or a Serving Gateway (SGW). The eNB is part of the radio access network 10, which in this case is the E-UTRAN (Evolved Universal Terrestrial Radio Access Network), while the MME and SGW are both part of the EPC (Evolved Packet Core network). The eNBs are inter-connected via the X2 interface, and connected to EPC via the S1 interface, more specifically via S1-C to the MME and S1-U to the SGW.

For wireless communication systems pursuant to 3GPP 5G System, 5GS (also referred to as New Radio, NR, or 5G) standard specifications, such as specified in 3GPP TS 38.300 and related specifications, on the other hand, the access nodes 103-104 corresponds typically to an 5G NodeB (gNB) and the network node 106 corresponds typically to either an Access and Mobility Management Function (AMF) and/or a User Plane Function (UPF). The gNB is part of the radio access network 10, which in this case is the NG-RAN (Next Generation Radio Access Network), while the AMF and UPF are both part of the 5G Core Network (5GC). The gNBs are inter-connected via the Xn interface, and connected to 5GC via the NG interface, more specifically via NG-C to the AMF and NG-U to the UPF.

To support fast mobility between NR and LTE and avoid change of core network, LTE eNBs may also be connected to the 5G-CN via NG-U/NG-C and support the Xn interface. An eNB connected to 5GC is called a next generation eNB (ng-eNB) and is considered part of the NG-RAN. LTE connected to 5GC will not be discussed further in this document; however, it should be noted that most of the solutions/features described for LTE and NR in this document also apply to LTE connected to 5GC. In this document, when the term LTE is used without further specification it refers to LTE-EPC.

NR uses Orthogonal Frequency Division Multiplexing (OFDM) with configurable bandwidths and subcarrier spacing to efficiently support a diverse set of use-cases and deployment scenarios. With respect to LTE, NR improves deployment flexibility, user throughputs, latency, and reliability. The throughput performance gains are enabled, in part, by enhanced support for Multi-User Multiple-Input Multiple-Output (MU-MIMO) transmission strategies, where two or more UEs receives data on the same time frequency resources, i.e., by spatially separated transmissions.

Sidelink (SL) communication is a direct data communication between wireless communications devices where the data traffic does not go through the communication network, for example without passing a base station. SL communication is beneficial for low-latency and high reliability data communication. 5G/NR SL has been introduced since 3GPP Release 16. Both Frequency Range 1 (FR1) and Frequency Range 2 (FR2) are supported in NR SL.

Today's synchronization method in NR SL uses a similar approach as for synchronization of the main link from the wireless communication network to a wireless communications device. That is, a complex signaling based on a Synchronization Signal Block (SSB) framework is standardized for NR SL synchronization wherein both participating wireless communications devices of the SL communication are synchronized to the wireless communication network. As a result, the existing mmWave sidelink synchronization method leads to high power consumption in wireless communications devices and long latency to setup sidelink communication between the wireless communications devices.

In mmWave SL, beam tracking between wireless communications devices is also very challenging. mmWave SL beam management is still lacking detailed specification. mmWave beam management in today's NR standard is more suitable for a centralized cellular wireless communication network where the base station controls the beam tracking procedure for all its associated UEs. The regular NR beam management procedure is generally based on SSBs and Channel State Information Reference Signals (CSI-RS). SSBs are periodically broadcast from a transmitter of the base station via beamforming. Each SSB is mapped to a given angular direction which may be identified by a unique SSB index. A receiver of a wireless communications device may perform periodic synchronization and beam detection by SSB reception and SSB index decoding. Then CSI-RS resource sets may be configured to refine the transmit and receive beam selection, to achieve beam alignment.

Therefore, a method is needed for Device-to-Device (D2D) synchronization and beam management, in particular for mmWave SL synchronization and beam management, to achieve lower power consumption of wireless communications devices and shorter time latency to setup D2D communication.

### SUMMARY

An object of embodiments herein is to obviate some of the problems related to D2D synchronization and beam management.

According to a first aspect, the object is achieved by a method, performed by a primary wireless communications device, for synchronization of D2D wireless communication between the primary wireless communications device and a secondary wireless communications device.

The method comprises broadcasting, on a D2D wireless communications channel, a single-tone synchronization signal for synchronization of the secondary wireless communications device to the primary wireless communications device, wherein broadcasting the single-tone synchronization signal comprises modulating the single-tone synchronization signal with a modulating data sequence.

According to a second aspect, the object is achieved by a primary wireless communications device for synchronization of D2D wireless communication between the primary wireless communications device and a secondary wireless communications device.

The primary wireless communications device is configured to perform the method according to the first aspect above.

According to a third aspect, the object is achieved by a method, performed by a secondary wireless communications device, for synchronization of D2D wireless communication between a primary wireless communications device and the secondary wireless communications device. The secondary wireless communications device comprises a first Radio Frequency, RF, receiver for wireless communication of data or control signals or both with the primary wireless communications device and a second RF receiver operating at a reduced power consumption compared to a power consumption of the first RF receiver when active.

The method comprises receiving, with the second RF receiver, on a D2D wireless communications channel, a single-tone synchronization signal for synchronization of the secondary wireless communications device to the primary wireless communications device, wherein the single-tone synchronization signal comprises a modulating data sequence.

The method further comprises comparing, a carrier frequency of the single-tone synchronization signal and a frequency of a Local Oscillator, LO, of the second RF receiver.

The method further comprises tuning a common reference oscillator of the first RF receiver and the second RF receiver based on a frequency difference between the carrier frequency of the single-tone synchronization signal and the frequency of the LO of the second RF receiver such that the frequency difference is tuned to a target value.

The method further comprises synchronizing the secondary wireless communications device in time with the primary wireless communications device based on the second RF receiver correlating the received modulating data sequence with a reference data sequence in time domain.

The method further comprises communicating, by the first RF receiver, control or data signals or both on the D2D wireless communications channel with the primary wireless communications device based on the tuned common reference oscillator and the time synchronization of the secondary wireless communications device with the primary wireless communications device.

According to a fourth aspect, the object is achieved by a secondary wireless communications device for synchronization of Device-to-Device, D2D, wireless communication between a primary wireless communications device and the secondary wireless communications device.

The wireless communications device is configured to perform the method according to the third aspect above.

According to a further aspect, the object is achieved by a computer program comprising instructions, which when executed on a wireless communications device causes the wireless communications device to perform actions according to the first or third aspect above.

According to a yet further aspect, the object is achieved by a carrier comprising the computer program of the further aspect above, wherein the carrier is one of an electronic signal, an optical signal, an electromagnetic signal, a magnetic signal, an electric signal, a radio signal, a microwave signal, or a computer-readable storage medium.

Since the secondary wireless communications device receives the single-tone synchronization signal comprising the modulating data sequence on the D2D wireless communications channel it is able to synchronize itself for D2D communication with the primary wireless communications device in a power-efficient way with low latency by using the low-power second RF receiver.

### BRIEF DESCRIPTION OF THE DRAWINGS

In the figures, features that appear in some embodiments are indicated by dashed lines.

The various aspects of embodiments disclosed herein, including particular features and advantages thereof, will be readily understood from the following detailed description and the accompanying drawings, in which:

FIG. 1 illustrates a simplified wireless communication system,

FIG. 2 illustrates a wireless communication system according to embodiments herein,

FIG. 3 illustrates embodiments of a D2D system,

FIG. 4 is a block diagram schematically illustrating a secondary communications device according to some embodiments herein,

FIG. 5 is a block diagram schematically illustrating further details of a secondary communications device according to some embodiments herein,

FIG. 6 is a block diagram schematically illustrating further details of a secondary communications device according to some embodiments herein,

FIG. 7 is a flowchart illustrating embodiments of a method performed by a primary wireless communications device,

FIG. 8 is a flowchart illustrating embodiments of a method performed by a wireless secondary communications device,

FIG. 9 illustrates further amplitude modulation patterns according to some embodiments herein,

FIG. 10 is a schematic block diagram illustrating embodiments of a primary wireless communications device,

FIG. 11 is a schematic block diagram illustrating embodiments of a secondary wireless communications device,

FIG. 12 schematically illustrates a telecommunication network connected via an intermediate network to a host computer.

FIG. 13 is a generalized block diagram of a host computer communicating via a base station with a user equipment over a partially wireless connection.

FIGS. 14 to 17 are flowcharts illustrating methods implemented in a communication system including a host computer, a base station and a user equipment.

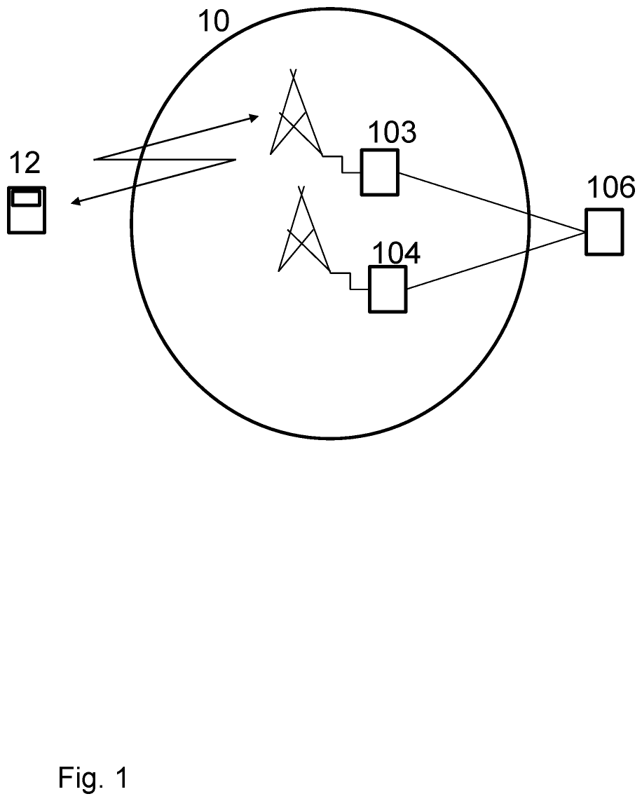

### DETAILED DESCRIPTION

Embodiments herein disclose a time and frequency synchronization and beam tracking method for D2D communication, such as SL communication, in particular for D2D communication on mmWave frequencies.

In embodiments herein a primary wireless communications device, which may be a master device in a master-slave relationship in which the master device controls one or more slave devices, broadcasts a single-tone synchronization signal modulated by a data sequence, such as an On-Off Keying (OOK) sequence.

A secondary wireless communications device, such as a slave device, receives the synchronization signal to perform frequency synchronization by for example either Fast Fourier Transform (FFT) or a digital filter bank. A digital filter bank is an array of bandpass filters that separates an input signal into multiple components, each one carrying a single frequency sub-band of the original signal.

Moreover, the secondary wireless communications device may achieve time synchronization with the primary wireless communications device by performing sequence correlation in time domain.

The single-tone synchronization signal may be easy to detect, or in other words to decode. When the single-tone synchronization signal is easy to detect it is possible to simplify the receiver design or implementation of the secondary wireless communications device or both and reduce its power consumption for frequency and time synchronization and beam tracking.

When the single-tone synchronization signal is received by multiple antenna elements or receiver branches of the secondary wireless communications device, the secondary wireless communications device is able to do Angle-of-Arrival (AoA) estimation of the single-tone synchronization signal.

Further, when the single-tone synchronization signal is received by multiple antenna elements or receiver branches of the secondary wireless communications device, the secondary wireless communications device is able to do D2D beam tracking of the beam direction from the secondary device towards to the primary wireless communications device, for receiving signals by the secondary wireless communications device which are transmitted by the first wireless communications device, and for transmitting signals from the secondary wireless communications device to be received by the first wireless communications device.

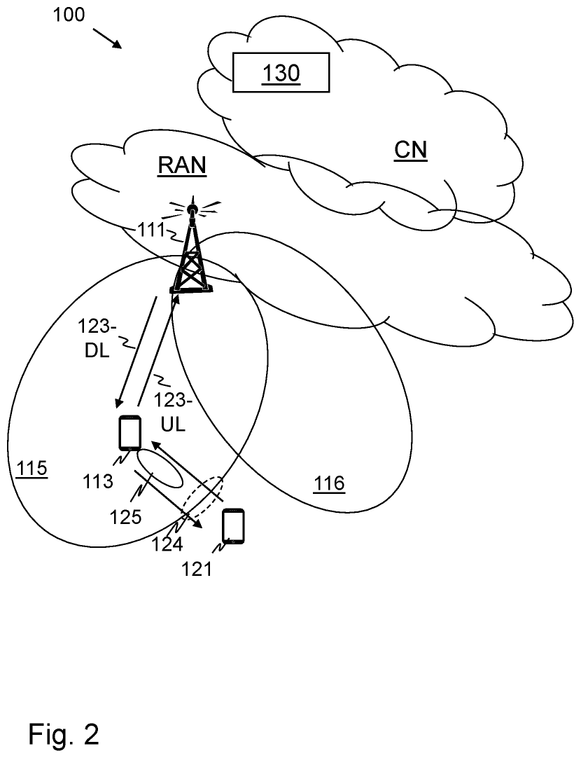

Embodiments herein relate to wireless communication networks in general. FIG. 2 is a schematic overview depicting a wireless communications network 100 wherein embodiments herein may be implemented. The wireless communications network 100 comprises one or more RANs and one or more CNs. The wireless communications network 100 may use a number of different technologies, such as Wi-Fi, Long Term Evolution (LTE), LTE-Advanced, 5G, New Radio (NR), Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of other existing wireless communication systems such as e.g. WCDMA and LTE and in future wireless communication systems, such as 6G systems.

Access nodes operate in the wireless communications network 100 such as a radio access node 111. The radio access node 111 provides radio coverage over a geographical area, a service area referred to as a cell 115, which may also be referred to as a beam or a beam group of a first radio access technology (RAT), such as 5G, LTE, Wi-Fi or similar. There may be more than one cell. For example, there may be a second cell 116 as well.

The radio coverage may further be provided by one or more narrow beams, specifically when mmWave frequencies are used for communication.

The radio access nodes may each be a NR-RAN node, transmission and reception point e.g. a base station, a radio access node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a wireless communications device within the service area depending e.g. on the radio access technology and terminology used. The respective radio access node may be referred to as a serving radio access node and communicates with a UE with Downlink (DL) transmissions to the UE and Uplink (UL) transmissions from the UE.

A number of wireless communications devices operate in the wireless communication network 100, such as a primary wireless communications device 113 and a secondary wireless communications device 121. Both the primary wireless communications device 113 and the secondary wireless communications device 121 are configured for D2D communication.

In a scenario the primary wireless communications device 113 is a master device and the secondary wireless communications device 121 is a slave device.

The wireless communications devices may each be a UE. Further, the wireless communications devices may each be a mobile station, a non-access point (non-AP) STA, a STA, a user equipment and/or a wireless terminal, that communicate via one or more Access Networks (AN), e.g. RAN, e.g. via the radio access node 111 to one or more core networks (CN) e.g. comprising a CN node 130, for example comprising an Access Management Function (AMF). It should be understood by the skilled in the art that “UE” is a non-limiting term which means any terminal, wireless communication terminal, user equipment, Machine Type Communication (MTC) device, D2D terminal, or node e.g. smart phone, laptop, mobile phone, sensor, relay, mobile tablets or even a small base station communicating within a cell.

Embodiments herein disclose a method for a wireless communications device to support improved synchronization of D2D communication with another wireless communications device.

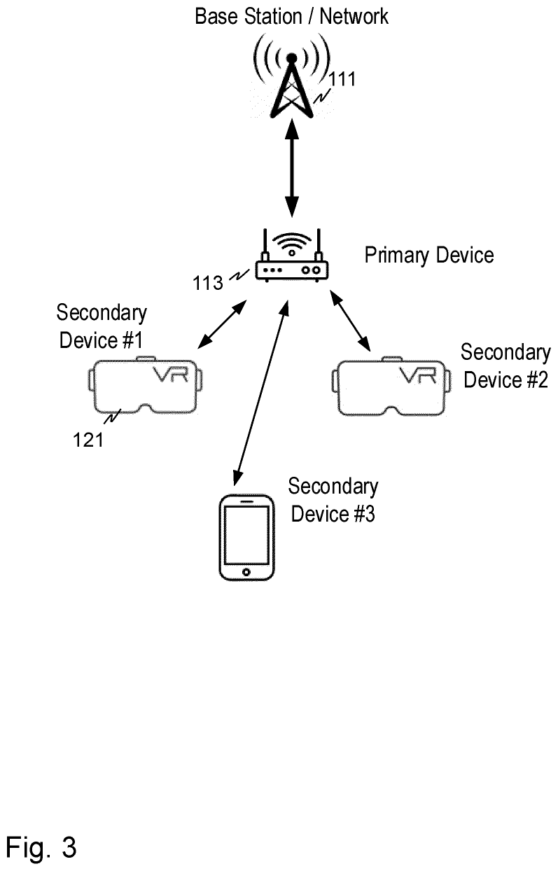

FIG. 3 illustrates embodiments of a D2D communication system. In FIG. 3 the primary wireless communications device 113 is connected to multiple wireless communications devices, such as the secondary wireless communications device 121. The multiple wireless communications devices may be slave devices, such as mobile phones, AR or VR glasses or both etc. A connection between the primary wireless communications device 113 and the secondary wireless communications device 121 is a D2D connection such as an SL connection. Thus, the primary wireless communications device 113 may communicate with the secondary wireless communications device 121 over a D2D wireless communications channel 124 illustrated in FIG. 2. The primary wireless communications device 113 may communicate with the secondary wireless communications device 121 over the D2D wireless communications channel 124 using one or more transmit or receive beams, of which a transmit beam 125 is illustrated in FIG. 2.

The primary wireless communications device 113 may further be connected to the wireless communications network 100 through the radio access node 111. The primary wireless communications device 113 may communicate with the radio access node 111 by transmitting data or control signals on an UL communications link UL-123 illustrated in FIG. 2. The primary wireless communications device 113 may also receive data or control signals from the radio access node 111 on a DL communications link DL-123 illustrated in FIG. 2.

However, it is not necessary for the primary wireless communications device 113 to be connected to the wireless communications network 100. For example, in a scenario in which embodiments herein may be implemented the primary wireless communications device 113 may be out of coverage of the wireless communications network 100.

A carrier for the D2D connection, such as a SL carrier, may be a mmWave-frequency radio signal, e.g. in NR FR2. Embodiments herein are particularly advantageous at mmWave frequencies since receivers at mmWave frequencies are very power hungry and embodiments herein lower the power consumption of receivers.

A link between the primary wireless communications device 113 and the wireless communications network 100 may be either on a low-frequency band, e.g. NR FR1, or on the mmWave-frequency band, e.g. NR FR2.

In some embodiments herein the primary wireless communications device 113 is able to perform frequency or time synchronization or both with the wireless communications network 100 by monitoring reference signals broadcast from the radio access node 111, via standardized methods, e.g. 3GPP NR standardized synchronization approach. The primary wireless communications device 113 may also select Global Navigation Satellite System (GNSS) as a synchronization source in case of being out of network coverage.

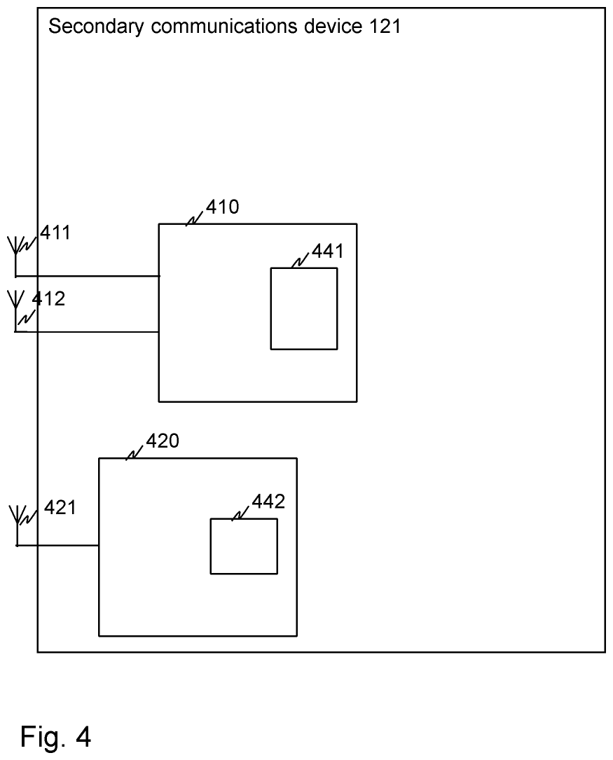

FIG. 4 is a block diagram schematically illustrating a secondary wireless communications device according to embodiments herein. The secondary wireless communications device 121 may e.g. be in communication with a primary wireless communication device. E.g. the primary communication device 113 as previously described. The secondary wireless communications device 121 comprises a first RF receiver 410 for wireless communication of data or control signals or both with the primary wireless communications device 113. The secondary wireless communications device 121 further comprises a second RF receiver 420 operating at a reduced power consumption compared to a power consumption of the first RF receiver 410 when active. That is, when the second RF receiver 420 is active it operates at a reduced power consumption compared to the power consumption of the first RF receiver 410 when the first RF receiver 410 is active. In some embodiments herein the first RF receiver 410 is referred to as a full receiver. The full receiver may also be referred to as a main receiver.

The reduced power consumption may for example be due to front end amplifiers with lower power demands or local oscillators with relaxed phase noise requirements or fewer front-end branches. In some other embodiments the reduced power consumption is due to analog to digital converters with less bandwidth and hence less power consumption. The second RF receiver 420 may also be connected to fewer antennas than the first RF receiver 410. For example, the first RF receiver 410 may be a wide-band, multi-antenna receiver, and the second RF receiver 420 may be a narrow-band, single-antenna receiver.

In FIG. 4 the first RF receiver 410 is connected to a first primary antenna element 411 and a second primary antenna element 412 while the second RF receiver 420 is connected to a secondary antenna element 421.

As mentioned above the second RF receiver 420 may be a separate receiver hardware block or a reduced-power operating mode of the first RF receiver 410.

The secondary wireless communications device 121 comprises at least one local oscillator (LO), e.g., for frequency conversion of received and transmitted RF signals. In electronics, an LO is an electronic oscillator used with a mixer to change the frequency of a signal. This frequency conversion process, also called heterodyning, produces signals at the sum and difference of the frequency of the LO and the frequency of the input signal. Processing a signal at a fixed center frequency after conversion gives a radio receiver improved performance. In many receivers, the function of LO and mixer is combined in one stage called a “converter”.

In some embodiments herein the first RF receiver 410 comprises or is connected to a first LO 441, while the second RF receiver 420 comprises or is connected to a second LO 442. The first and second LOs 441, 442 may for example be used for frequency conversion by the respective first and second RF receiver 410, 420.

The second LO 442 may be used for frequency conversion of a single-tone synchronization signal from the primary wireless communications device 113. The first LO 441 may be used for frequency conversion of data or control signals, e.g., to and from the primary wireless communications device 113. The first LO 441 may be optimized for high performance, while the second LO 442 may be optimized for low power. In some embodiments herein the second LO 442 comprises common components with the first LO 441. For example, all components of the first LO 441 may be common with the second LO 442. In such embodiments the common components may be reconfigurable. An advantage of using common components for the first LO 441 and the second LO 442 is that less space is needed for the RF receivers. The frequency of the single-tone synchronization signal may be in a same frequency range as used for the carrier for the D2D connection between the primary wireless communications device 113 and the secondary wireless communications device 121. For example, the single-tone synchronization signal may be in the mmWave range, such as in 3GPP FR2. Using the mmWave spectrum for broadcasting the single-tone synchronization signal is advantageous since currently there are many free frequencies in this frequency range.

The second LO 442 may be a low-power and low-cost LO compared to the first LO 441.

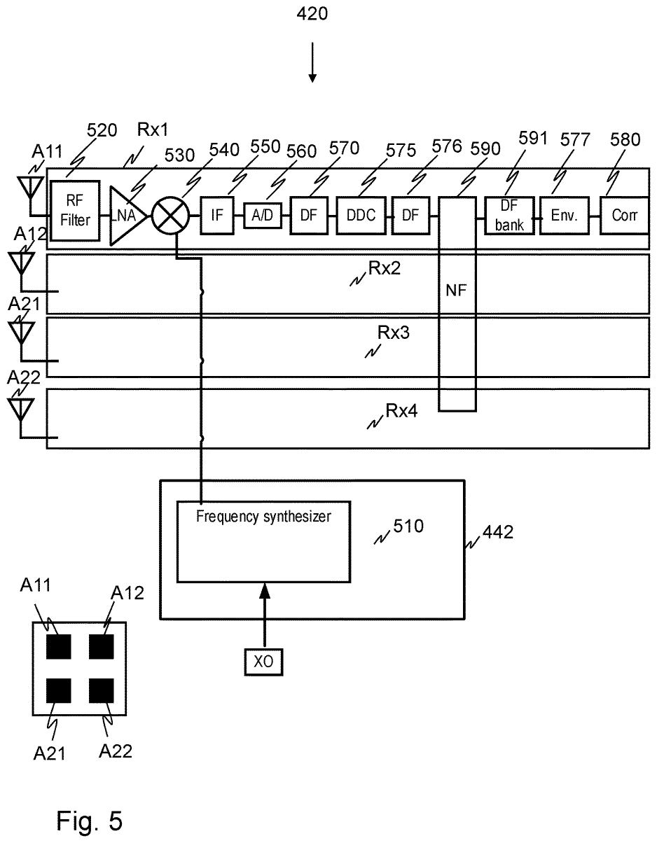

FIG. 5 is a block diagram schematically illustrating further details of the secondary wireless communications device 121 and the second RF receiver 420 according to embodiments herein.

In FIG. 5 the second RF receiver 420 is illustrated as a heterodyne receiver. However, a homodyne receiver may also be used at the expense of using quadrature mixers and quadrature LO signal. The heterodyne receiver may save power compared to a homodyne receiver with quadrature RF mixers, e.g., when operating with a low IF and so that the image frequency falls inside a quiet band, such as a guard band.

The first and second LOs 441, 442 may each comprise a frequency synthesizer such as a frequency synthesizer 510 of the second LO 442 illustrated in FIG. 5. Each frequency synthesizer may comprise a Voltage-Controlled Oscillator (VCO). Each frequency synthesizer may further comprise or be connected to a reference oscillator such as a common reference oscillator XO. Each reference oscillator, such as the common reference oscillator XO, may be a crystal oscillator. The crystal oscillator may be an electronic oscillator circuit that uses a piezoelectric crystal as a frequency-selective element. The crystal oscillator may maintain a reference frequency with high stability.

Although the first RF receiver 410 and the second RF receiver 420 may have separate LOs they may still use the same frequency reference, that is the same reference oscillator XO. By using the same reference oscillator XO it is possible to adjust the frequency reference of the first RF receiver 410 based on the synchronization signal received with the second RF receiver 420.

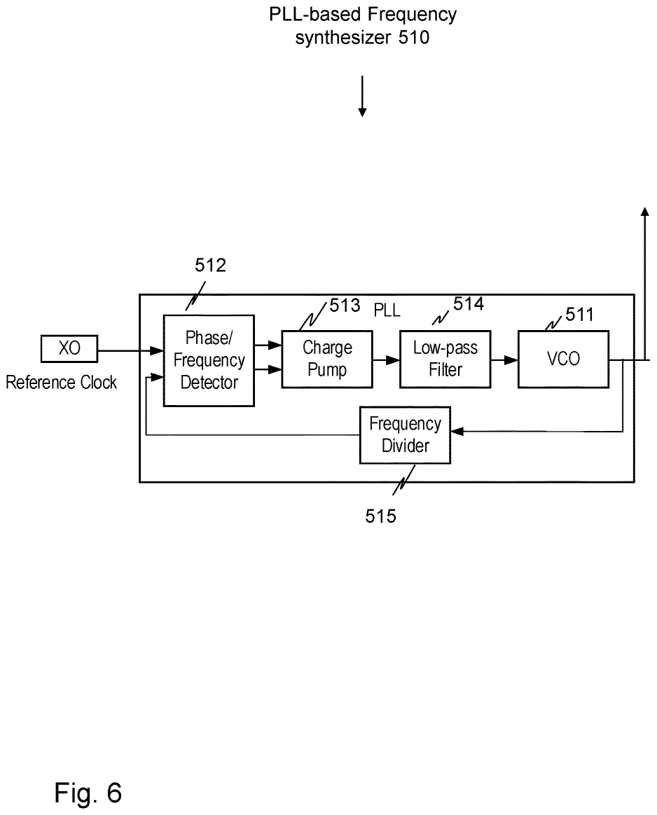

Each frequency synthesizer may be based on a Phased-Locked Loop (PLL). FIG. 6 shows basic elements and an arrangement of a PLL-based frequency synthesizer, such as the frequency synthesizer 510 of the second LO 442. Thus, the second LO 442 may comprise a PLL. The PLL-based frequency synthesizer 510 is a feedback control system. It compares the phases of two input signals at a phase-frequency detector 512 and produces an error signal that is proportional to the difference between their phases. A first input signal is derived from a signal from the common reference oscillator XO. The error signal may pass through a charge pump 513 and is then low pass filtered in a low-pass filter 514 and used to drive a VCO 511 which creates an output frequency. The output frequency is fed through a frequency divider 515 back to the input of the system, producing a negative feedback loop. Thus, a second input signal is derived from the output of the VCO 511 after frequency division by the frequency divider 515.

If the output frequency of the VCO 511 drifts, the phase error signal will increase, driving the frequency in the opposite direction so as to reduce the error. Thus, the output is locked to the frequency of the reference oscillator XO at the other input.

Turning back to FIG. 5, the second RF receiver 420 may comprise one or more receiver branches Rx1, Rx2, Rx3, Rx4. Each receiver branch Rx1, Rx2, Rx3, Rx4 may be connected to an antenna element A11, A12, A21, A22. For example, a first receiver branch Rx1 may be connected to a first secondary antenna element A11. A second receiver branch Rx2 may be connected to a second secondary antenna element A12 and so forth.

In FIG. 5 only the components of the first receiver branch Rx1 is shown for simplicity. However, each receiver branch Rx1, Rx2, Rx3, Rx4 may comprise the components of the first receiver branch Rx1. Thus, according to FIG. 5 each receiver branch Rx1, Rx2, Rx3, Rx4 may comprise the following components in the following or any other suitable order: an RF filter 520, a Low Noise Amplifier (LNA) 530, an RF Mixer 540, an Intermediate Frequency (IF) filter 550, an Analog Digital Converter (ADC) 560, a first digital filter 570, a Digital DownConverter (DDC) 575, a second digital filter 576, an envelope detector 577 for rectification of the signal and a correlator 580. The second digital filter 576, after the DDC 575, will remove unwanted mixing components around 2*IF frequency. The envelope detector 577 may be disabled when the frequency synchronization is accurate enough to support AoA detection. If the envelope detector 577 is used then the output of the correlator is a real number. If the envelope detector 577 is not used, the correlator works on complex input data: I and Q. The correlator then outputs a complex number which may be described with a magnitude and a phase and may be used to estimate AoA.

As shown in FIG. 5 the second RF receiver 420 in the secondary wireless communications device 121 may be equipped with four separate antenna elements arranged in a 2×2 matrix (two horizontal and two vertical antenna elements illustrated in the lower left corner of FIG. 5), to which four receiver branches are connected, with separated LNA, downconversion mixer, filter, ADC, digital filter and correlator. The receiver branches, using the same LO signal for all the mixers and the same digital LO signal for the digital downconversion when applicable, e.g., in the heterodyne case, may then be used to detect the single-tone synchronization signal which is transmitted by the primary wireless communications device 113.

Although FIG. 5 illustrates the secondary wireless communications device 121 comprising four secondary antenna elements A11, A12, A21, A22 connected to four receiver branches Rx1, Rx2, Rx3, Rx4 of the second RF receiver 420 some embodiments herein disclose a single-antenna and single-receiver branch second RF receiver 420.

The secondary wireless communications device 121 may further comprise a nullforming unit (NF) 590. The nullforming unit 590 may be digital. The second RF receiver 420 may comprise the nullforming unit 590. The nullforming unit 590 is connected to two or more of the receiver branches Rx1, Rx2, Rx3, Rx4. For example, in some embodiments herein the nullforming unit 590 is connected to all receiver branches Rx1, Rx2, Rx3, Rx4. Some embodiments herein utilize the fact that when the number of antenna elements is small, an RF reception null is sharper than the corresponding receive beam, which may be used for estimating an AoA of the transmitted beam.

After the nullforming unit 590, there may also be a bank of parallel complex digital bandpass filters 591, each followed by a respective envelope detector 577 and correlator 580. The respective digital filter of the bank of digital filters is tuned to a centre frequency which is different from the other centre frequencies of the other digital filters of the bank of digital filters, to find if the received synchronization signal has a corresponding frequency offset from the frequency where the synchronization signal would occur without frequency errors.

An amplitude modulation pattern may be applied to the synchronization signal. One example is a periodic on-off keying pattern with 90% on and 10% off, where the power is reduced by just 0.46 dB compared to a non-modulated tone being on 100% of the time.

A periodicity of the modulation pattern may be selected based on multiple considerations. For example, the off-segment(s) may be kept as short a fraction of the period as possible, to avoid losing energy, e.g., total synchronization signal energy. Alternatively, the synchronization signal may be power-boosted with the inverse of the duty cycle, in which case the received power is not affected. The modulation pattern may be kept as long as possible in absolute terms to allow as narrow receiver bandwidth of the second RF receiver 420 as possible to maximize the Signal to Noise Ratio (SNR). If the period of the modulation pattern is for instance 1 ms and the duty cycle of the modulation pattern is 90%, a channel filter of the second RF receiver 1020 may have as low bandwidth as 10 KHz and still capture waveforms. The bandwidth may be just 3-4 kHz if the duty cycle is reduced to 70%.

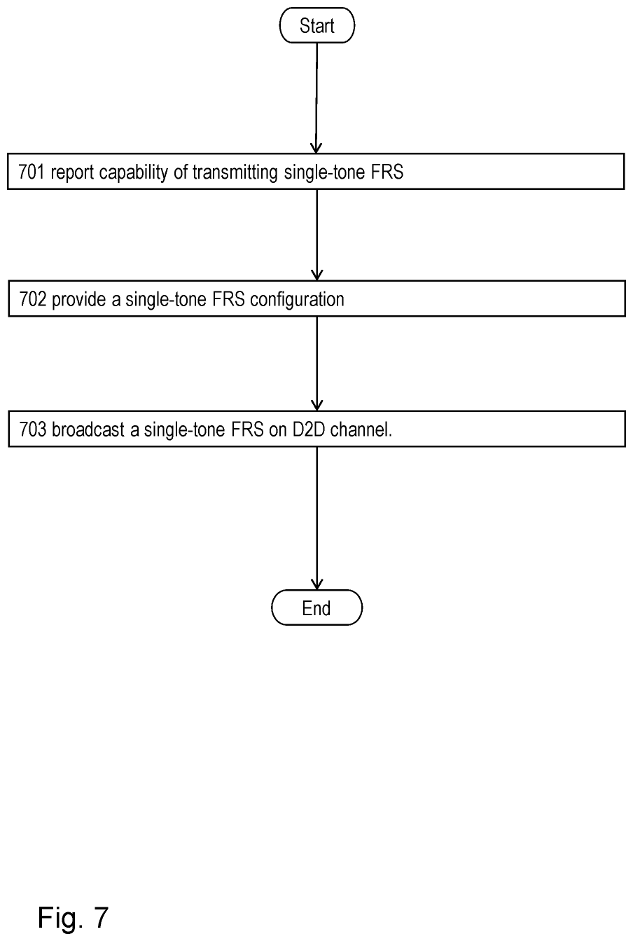

Exemplifying methods according to embodiments herein will now be described with reference to a flow chart in FIG. 7 and with continued reference to FIGS. 2, 3, 4, 5a, 5b and 6. The flow chart illustrates a method, performed by the primary wireless communications device 113, for synchronization of D2D wireless communication between the primary wireless communications device 113 and the secondary wireless communications device 121.

### Action 701

In some embodiments herein the primary wireless communications device 113 reports a capability, associated with the primary wireless communications device 113, of transmitting the single-tone synchronization signal, to the network node 111 of the wireless communications network 100 in which the primary wireless communications device 113 and the secondary wireless communications device 121 operate. In this way, if the secondary wireless communications device 121 doesn't receive information from the wireless communications network 100 about the capability of the primary wireless communications device 113 or other primary wireless communications devices then it may derive that there is no primary wireless communications device 113 that may send such D2D synchronization signal and it may then turn off the low-power second RF receiver 420.

Furthermore, the secondary wireless communications device 121 may receive important information about the D2D synchronization signal based on the reported capability. For example, the secondary wireless communications device 121 may be informed about a configuration of the D2D synchronization signal such that it knows at which frequency range it should listen to for the D2D synchronization signal.

### Action 702

The primary wireless communications device 113 may provide a single-tone synchronization signal configuration to the secondary wireless communications device 121. In this way the secondary wireless communications device 121 may for example learn at which frequency range it should listen to for the D2D synchronization signal.

### Action 703

In order to synchronize D2D wireless communication between the primary wireless communications device 113 and the secondary wireless communications device 121 the primary wireless communications device 113 broadcasts on the D2D wireless communications channel 124 the single-tone synchronization signal for synchronization of the secondary wireless communications device 121 to the primary wireless communications device 113, wherein broadcasting the single-tone synchronization signal comprises modulating the single-tone synchronization signal with a modulating data sequence. The single-tone synchronization signal may be broadcasted periodically. In some embodiments herein the single-tone synchronization signal is transmitted from multiple antennas by beamforming and beam sweeping. In some embodiments herein the single-tone synchronization signal is transmitted omni-directionally.

In some embodiments herein modulating the single-tone synchronization signal with the modulating data sequence comprises modulating an amplitude of the single-tone synchronization signal. The modulation format may be OOK. However, other modulation formats which preferably are simple, such as Phase Shift Keying (PSK) and Frequency Shift Keying (FSK), are also possible. OOK is particularly advantageous, as it has no phase modulation that may affect the frequency synchronization, and that the modulation may be easily decoded also without first obtaining accurate frequency synchronization, e.g., by performing an envelope detection before the correlation of the data sequences. The data sequence may further include an indication of an identity of the primary wireless communications device 113, a beam index or any other additional information, like requests to start communication, state of other wireless communications devices which are connected to the primary wireless communications device 113, etc. It may also contain a reference sequence for time synchronization by correlation with the reference sequence in time domain.

Thus, the data sequence may indicate any one or more of: a transmit beam 125 of the primary wireless communications device 113 used for the synchronization signal, an identity of the primary wireless communications device 113, a reference sequence known to the secondary wireless communications device 121, or a time stamp. The time stamp may be an absolute time from the primary wireless communications device 113, a System Frame Number (SFN) from the wireless communications network 100. The time stamp may also be part of a timing as a service.

When transmitting the single-tone synchronization signal, the primary wireless communications device 113 may adapt the bit rate of the modulating data sequence according to the required time synchronization precision between the primary wireless communications device 113 and the secondary wireless communications device 121. In some embodiments, the transmitted modulating data sequence may start with a low bit rate sequence and increase its bit rate after a certain period of the low bit rate sequence.

The receiver of the secondary wireless communications device 121 may then perform a rough time synchronization by detecting, e.g., by correlating, the low bit rate sequence in a wide search space in time such as plus minus 10 ms, and then refine its time synchronization by detecting the high bit rate sequence, by reducing the search space in time, e.g., to plus minus 100 microseconds, based on the rough time synchronization result. The modulating data sequence may be detected by finding a correlation peak in time domain.

Thus, in some embodiments herein a bitrate of the modulating data sequence is adapted according to a required precision of time synchronization of the secondary wireless communications device 121 to the primary wireless communications device 113.

The modulating data sequence may comprise a first low bit rate sequence and a second high bit rate sequence.

In some embodiments herein the single-tone synchronization signal is broadcasted using a gap band in a frequency spectrum of the D2D wireless communications channel 124 or in a frequency spectrum of the communications link 123-DL, 123-UL between the primary wireless communications device 113 and the radio access node 111.

The gap band may also be referred to as a guard band. The guard band may be a guard band in a licensed spectrum. A guard band may be a narrow frequency range that separates two wider frequency ranges for communication so that the two communication channels may be simultaneously used without experiencing interference. For example, in case of a channel bandwidth of 200 MHz, NR FR2 with a subcarrier spacing of 120 kHz, the guard band may be 4.9 MHz. This is wide enough for an OOK sequence with a bit rate of 500 kbps. The frequency of the synchronization signal may also be selected in an unlicensed mmWave spectrum. Using a guard band in the mmWave spectrum for broadcasting the single-tone synchronization signal is advantageous since currently there are many free frequencies in this frequency range.

The bandwidth of the single-tone synchronization signal may be below 1 MHz, or below 100 kHz, or below 10 KHz.

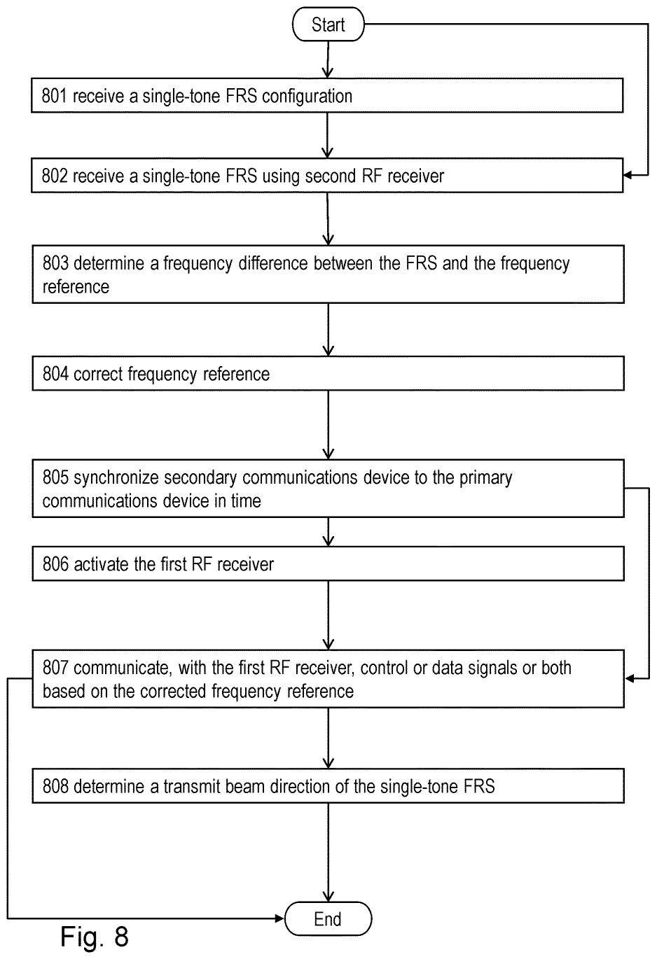

Exemplifying methods according to embodiments herein will now be described with reference to a flow chart in FIG. 8 and with continued reference to FIGS. 2, 3, 4, 5a, 5b and 6. The flow chart illustrates a method, performed by the secondary wireless communications device 121, for synchronization of D2D wireless communication between the primary wireless communications device 113 and the secondary wireless communications device 121.

As mentioned above the secondary wireless communications device 121 comprises the first RF receiver 410 for wireless communication of data or control signals or both with the primary wireless communications device 113 and the second RF receiver 420 operating at the reduced power consumption compared to the power consumption of the first RF receiver 410 when active.

### Action 801

In some embodiments herein the secondary wireless communications device 121 receives a synchronization signal configuration of the single-tone synchronization signal.

### Action 802

In order to synchronize D2D wireless communication between the primary wireless communications device 113 and the secondary wireless communications device 121 the secondary wireless communications device 121 receives, with the second RF receiver 420, on the D2D wireless communications channel 124, the single-tone synchronization signal, for synchronization of the secondary wireless communications device 121 to the primary wireless communications device 113, wherein the single-tone synchronization signal comprises a modulating data sequence.

In actions below the secondary wireless communications device 113 performs frequency synchronization to the received single-tone signal e.g. to tune the LO frequency of the second RF receiver 420 so that the locally generated carrier frequency aligns to the carrier frequency of the received single-tone signal. Furthermore, the secondary wireless communications device 113 may perform time synchronization by correlating the received data sequence with a reference data sequence.

As mentioned above when action 703 was described, the modulating data sequence may indicate any one or more of: the transmit beam 125 of the primary wireless communications device 113 used for the single-tone synchronization signal, the identity of the primary wireless communications device 113, the reference sequence known to the secondary wireless communications device 121, or the time stamp.

In some embodiments herein receiving the single-tone synchronization signal comprises: detecting, by the second RF receiver 420, a degradation of received Signal Strength (RSS) from the first receiver branch Rx1 connected to the first secondary antenna element A11, above a threshold degradation value, and in response to detecting the degradation of RSS from the first receiver branch Rx1 activating, by the second RF receiver 420, a second receiver branch Rx2 which is connected to the second secondary antenna element A22 adjacent to the first secondary antenna element A11.

The secondary wireless communications device 121 may further deactivate the first receiver branch Rx1 in response to activating the second receiver branch Rx2.

As mentioned above, the second RF receiver 420 may be equipped with multiple receiver branches Rx1, Rx2, Rx3, Rx4. Then the single-tone synchronization signal may be received by sequentially receiving the single-tone synchronization signal with different single receiver branches of the multiple receiver branches Rx1, Rx2, Rx3, Rx4 or with different combinations of the multiple receiver branches Rx1, Rx2, Rx3, Rx4.

In some example embodiments herein the second RF receiver 420 may first activate a single receiver branch to detect a frequency or a timing of the single-tone synchronization signal or both. In case SNR of the received single-tone synchronization signal is low, e.g. if the antenna of the single receiver branch is in a deep fade position, another receiver branch may be enabled or more than one receiver branch may be enabled.

The LO frequency of the second RF receiver 420 may be tuned until the modulating data sequence, such as the OOK amplitude pattern, is found when demodulating the digital received single-tone synchronization signal. Here a search for the single-tone synchronization signal may be called for with different digital filtering dependent on the strength of the single-tone synchronization signal. When the single-tone synchronization is found it may be tracked by using different digital filters of the bank of digital filters 591 in FIG. 5, e.g. one centered around the frequency where the synchronization signal would occur without frequency errors, one higher and one lower in frequency, and comparing the results from rectification and correlation of the filtered signals, and adjusting the second LO 452 in response to which signal is strongest.

### Action 803

The secondary wireless communications device 121 compares, a carrier frequency of the single-tone synchronization signal and a frequency of the LO 442 of the second RF receiver 420. The comparison may be performed by the second RF receiver 420.

### Action 804

Tuning the common reference oscillator XO of the first RF receiver 410 and the second RF receiver 420 based on a frequency difference between the carrier frequency of the single-tone synchronization signal and the frequency of the LO 442 of the second RF receiver 420 such that the frequency difference is tuned to a target value. In the homodyne case the target value of the difference may be zero, while in the heterodyne case the target value may be a target IF frequency which is non-zero.

The carrier frequency of the single-tone synchronization signal may be determined by tuning the frequency of the common reference oscillator XO until a pattern of the modulating data sequence is found when demodulating the single-tone synchronization signal. The above method of tuning the frequency of the common reference oscillator XO until the pattern of the modulating data sequence is found may be applicable when a single fixed IF filter 550 is used.

In some other embodiments the carrier frequency of the single-tone synchronization signal may be determined by applying different IF filters centred at different IF frequencies, tuning the frequency of the common reference oscillator XO and finding at which filter output the synchronization signal is strongest.

### Action 805

Synchronizing the secondary wireless communications device 121 in time with the primary wireless communications device 113 based on the second RF receiver 420 correlating the received modulating data sequence with a reference data sequence in time domain. When the two devices are synchronized it means they have a common understanding of when transmissions start and end.

Synchronizing the secondary wireless communications device 121 in time with the primary wireless communications device 113 may further be based on the tuning of the common reference oscillator XO of the first RF receiver 410 and the second RF receiver 420. For example, synchronization in time may comprise tuning the frequency of the reference oscillator XO and finding a peak of a correlation signal with respect to the tuned frequency by using a digital clock frequency derived from the tuned frequency of the reference oscillator XO.

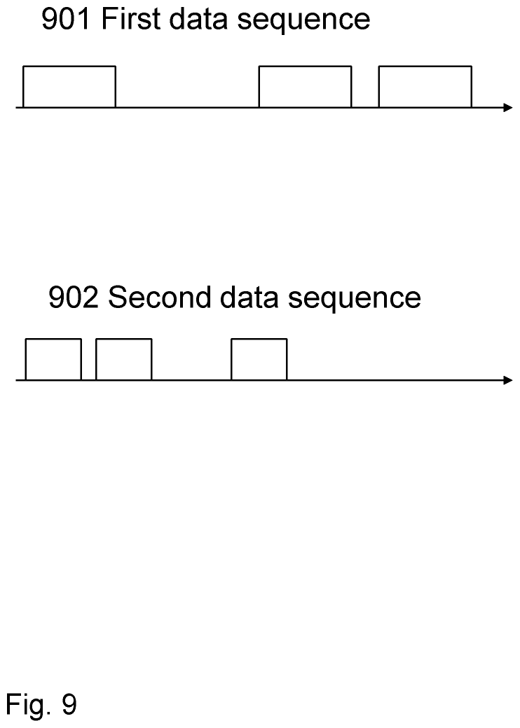

In some embodiments herein the modulating data sequence comprises a first data sequence 901 and a second data sequence 902, both illustrated in FIG. 9. The second data sequence 902 has a higher bit rate than the first data sequence 901. Thus, the second data sequence 902 may be a high bit rate data sequence and the first data sequence 901 may be a low bit rate data sequence. Then the synchronizing may comprise a first rough time synchronization by correlating the received first data sequence 901 with a first reference data sequence, and then a second refined time synchronization by correlating the received second data sequence 902 with a second reference data sequence over a time interval derived from the first rough time synchronization.

### Action 806

The secondary wireless communications device 121 may activate the first RF receiver 410, for example if the first RF receiver 410 has been in a low-power mode.

### Action 807

The secondary wireless communications device 121 communicates, by the first RF receiver 410, control or data signals or both on the D2D wireless communications channel with the primary wireless communications device 113 based on the tuned common reference oscillator XO and the time synchronization of the secondary wireless communications device 121 with the primary wireless communications device 113.

### Action 808

AoA estimation may be performed on the single-tone synchronization signal if there are multiple antenna elements for reception of the single-tone synchronization signal. Specifically, estimation of the AoA may be performed to be able to direct transmit and receive beams of the secondary wireless communications device 121 towards the primary wireless communications device 113. If the secondary wireless communications device 121 comprises four receiver branches then two receiver branches may be enabled for searching a transmitted signal in one dimension or four receiver branches may be enabled for searching for the transmitted signal in two dimensions. Further, nullforming may be performed for finding the transmitted signal as the number of antenna elements is small, and an RF reception null is sharper than the corresponding receive beam.

The secondary wireless communications device 121 may search for a beam direction until a detected signal related to the transmitted signal disappears. An OOK modulation pattern of the synchronization signal will not be detected in the null direction although it is clearly detected in beam directions adjacent a null direction. Once the null direction is found, the AoA of the transmitted beam may be estimated as the null direction. Then the second RF receiver 420 may form a beam in the estimated beam direction when the SL communication is initialized.

As an alternative, when the frequency of the second LO 542 has been tuned to sufficient accuracy, the multiple receiver branches are used, and the phase of their correlation peaks are compared, which provides information about the relative received carrier phases. The relative carrier phases may be translated into an AoA in azimuth and elevation angles. For this to work the frequency of the second LO 542 may first be tuned to an accuracy substantially better than 1/(2Tcorr), where Tcorr is the correlation time.

Thus, the secondary wireless communications device 121 may determine a receive direction of the single-tone synchronization signal by estimating an angle of arrival based on a detected coincidence of a radiation null formed by a combination of the multiple receiver branches Rx1, Rx2, Rx3, Rx4 and the received single-tone synchronization signal during null sweeping with the second RF receiver 420.

In some embodiments herein the secondary wireless communications device 121 determines the receive direction of the single-tone synchronization signal based on comparing a first phase of a first correlation peak from the first receiver branch Rx1 with a second phase of a second correlation peak from the second receiver branch Rx2. The comparison of the correlation peaks provides information about the relative received carrier phases in the first receiver branch Rx1 and the second receiver branch Rx2. The relative carrier phases may be translated into an AoA estimation.

SL Synchronization Signal Transmitted and Received with Single Antenna

A calculation of the SL link budget between the primary wireless communications device 113 and the secondary wireless communications device 121 where both wireless communications devices 113, 121 are equipped with a single antenna each is disclosed below with the below assumptions on the transmitter at the primary wireless communications device 113 and the second RF receiver 420 at the secondary wireless communications device 121:

$$Carrier frequency = 30 GHz$$

$$Noise BW = 100 kHz$$

$$Tx power = 0 dBm$$

$$Tx and Rx Antenna gain = 3 dB$$

$$Rx noise figure = 10 dB$$

The required SNR of the second RF receiver is 15 dB.

Based on the above numbers the estimated SL synchronization range is 140 meters in Line of Sight (LoS). By increasing the transmit power, the range may be further extended. These numbers also indicate that it is possible to use single antenna elements on both receiver and transmitter to measure the phase relations. For example, there is sufficient SNR for demodulation using a single antenna element. If there are multiple antenna elements in the receiver, the received carrier phase may be determined for each antenna element. From the received carrier phases the angle of arrival may be determined using the correlators as described above. The correlators improve the SNR even more with their processing gain. If the bandwidth of the single-tone signal is narrow, providing high spectral density, the transmitter may not need to perform beamforming to transmit the single-tone signal to achieve high SNR.

Receiver with Multiple Antennas

As the single-tone synchronization signal may have very narrow bandwidth, the second RF receiver 420 may suffer from a deep fading channel. A fading channel is a communication channel that experiences fading. Strong destructive interference is frequently referred to as a deep fade and may result in temporary failure of communication due to a severe drop in the channel signal-to-noise ratio.

For the single-receiver antenna of the secondary wireless communications device 121 moving a very short distance, e.g. a fraction of one wavelength, the second RF receiver 420 may change from good reception to a serious degradation of received signal strength as the signal experience severe destructive interference at the antenna location. To cope with this deep fading issue, once the second RF receiver 420 detects a serious degradation of RSS from one antenna element, the second RF receiver 420 may switch on another receiver branch which is connected to an antenna element adjacent to the original one. In one embodiment, the second RF receiver 420 may switch off the original receiver branch to reduce power consumption of the second RF receiver 420.

Furthermore, by using multiple antennas, the AoA of the transmitted synchronization signal may be estimated. For example, the transmit beam 125 may be estimated for beam tracking of the transmitted beam 125 from the primary wireless communications device 113. In one embodiment, the second RF receiver 420 with multiple receiver branches is enabled to perform nullforming (as the number of antenna elements is small, an RF reception null is sharper than the beam itself). By sweeping the RF reception null, the second RF receiver 420 may estimate the AoA of the transmitted signal. Then the second RF receiver 420 may adjust its reception beam according to the estimated AoA so that the beam alignment between the transmitter and the second RF receiver 420 may be achieved.

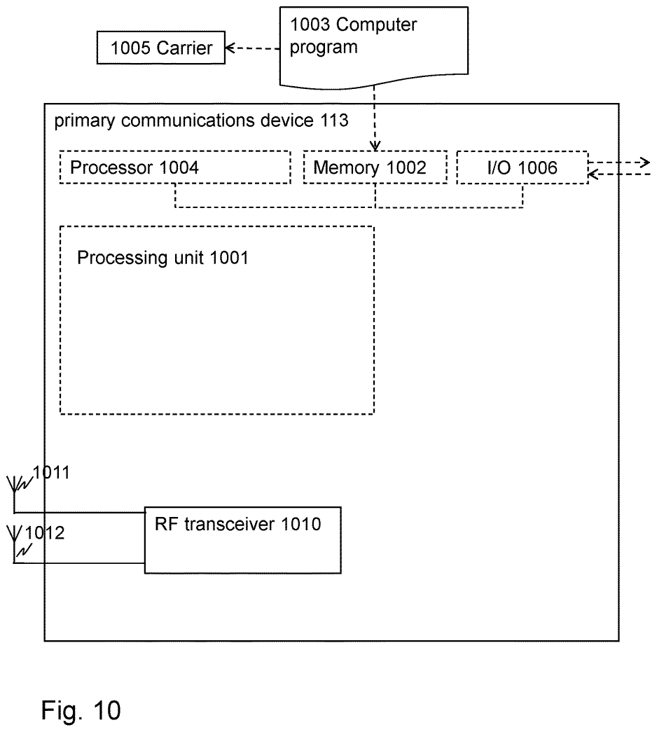

FIG. 10 illustrates a schematic block diagram of embodiments of the primary wireless communications device 113. The primary wireless communications device 113 is configured to perform the method of FIG. 7. Thus, the primary wireless communications device 113 is configured for synchronization of D2D wireless communication between the primary wireless communications device 113 and a secondary wireless communications device 121.

The primary wireless communications device 113 is further configured to broadcast, on the D2D wireless communications channel SL, the single-tone synchronization signal, for synchronization of the secondary wireless communications device 121 to the primary wireless communications device 113. Broadcasting the single-tone synchronization signal comprises modulating the single-tone synchronization signal with the modulating data sequence.

As illustrated in FIG. 10 the primary wireless communications device 113 may comprise an RF transceiver 1010 electrically connected to one or more antenna elements 1011, 1012.

The primary wireless communications device 113 may be further configured to modulate the single-tone synchronization signal with the modulating data sequence by modulating the amplitude of the single-tone synchronization signal.

The primary wireless communications device 113 may be further configured to broadcast the single-tone synchronization signal is using the gap band in the frequency spectrum of the D2D wireless communications channel SL or in the frequency spectrum of the communications link 123-DL, 123-UL between the primary wireless communications device 113 and the radio access node 111.

The primary wireless communications device 113 may be further configured to adapt the bitrate of the modulating data sequence according to the required precision of time synchronization of the secondary wireless communications device 121 to the primary wireless communications device 113.

In some embodiments herein the primary wireless communications device 113 is further configured to: report the capability, associated with the primary wireless communications device 113, of transmitting the single-tone synchronization signal, to the network node 111 of the wireless communications network 100 in which the primary wireless communications device 113 and the secondary wireless communications device 121 operate.

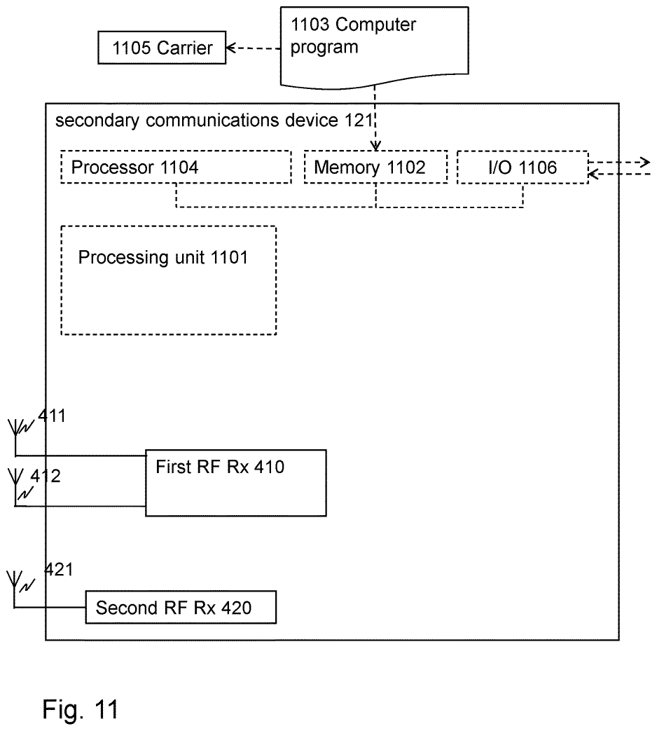

FIG. 11 illustrates a schematic block diagram of embodiments of the secondary wireless communications device 121. The secondary wireless communications device 121 is configured to perform the method of FIG. 4. Thus, the secondary wireless communications device 121 is configured for synchronization of D2D wireless communication between the primary wireless communications device 113 and the secondary wireless communications device 121.

As mentioned above, the secondary wireless communications device 121 comprises the first RF receiver 410 for wireless communication of data or control signals or both with the primary wireless communications device 113 and the second RF receiver 420 operating at the reduced power consumption compared to the power consumption of the first RF receiver 410 when active.

The secondary wireless communications device 121 is further configured to:
receive, with the second RF receiver 420, on the D2D wireless communications channel, the single-tone synchronization signal for synchronization of the secondary wireless communications device 121 to the primary wireless communications device 113, wherein the single-tone synchronization signal comprises the modulating data sequence;
compare, the carrier frequency of the single-tone synchronization signal and the frequency of the Local Oscillator, LO, 442 of the second RF receiver 420;
tune the common frequency reference XO of the first RF receiver 410 and the second RF receiver 420 based on the frequency difference between the carrier frequency of the single-tone synchronization signal and the frequency of the LO 442 of the second RF receiver 420 such that the frequency difference is tuned to a target value;
synchronize the secondary wireless communications device 121 in time with the primary wireless communications device 113 based on the second RF receiver 420 correlating the received modulating data sequence with the reference data sequence in time domain; and
communicate, by the first RF receiver 410, control or data signals or both on the D2D wireless communications channel with the primary wireless communications device 113 based on the tuned common frequency reference XO and the time synchronization of the secondary wireless communications device 121 with the primary wireless communications device 113.

In some embodiments herein the secondary wireless communications device 121 is further configured to determine the carrier frequency of the single-tone synchronization signal by tuning the frequency of the common frequency reference XO until the pattern of the modulating data sequence is found when demodulating the single-tone synchronization signal.

When the modulating data sequence comprises the first data sequence 901 and the second data sequence 902 with the higher bit rate than the first data sequence 901 then the secondary wireless communications device 121 may be further configured to perform synchronizing which comprises, the first rough time synchronization by correlating the received first data sequence 901 with the first reference data sequence, and then the second refined time synchronization by correlating the received second data sequence 902 with the second reference data sequence over the time interval derived from the first rough time synchronization.

In some embodiments herein the second RF receiver 420 is equipped with multiple receiver branches Rx1, Rx2, Rx3, Rx4, and then the secondary wireless communications device 121 may be configured to receive the single-tone synchronization signal by sequentially receiving the single-tone synchronization signal with different single receiver branches of the multiple receiver branches Rx1, Rx2, Rx3, Rx4 or with different combinations of the multiple receiver branches Rx1, Rx2, Rx3, Rx4.

The secondary wireless communications device 121 may be further configured to determine the receive direction of the single-tone synchronization signal by estimating an angle of arrival based on the detected coincidence of the radiation null formed by the combination of the multiple receiver branches Rx1, Rx2, Rx3, Rx4 and the received single-tone synchronization signal during null sweeping with the second RF receiver 420.

The secondary wireless communications device 121 may be further configured to determine the receive direction of the single-tone synchronization signal based on comparing the first phase of the first correlation peak from the first receiver branch Rx1 with the second phase of the second correlation peak from the second receiver branch Rx2.

In some embodiments the secondary wireless communications device 121 is further configured to receive the single-tone synchronization signal by detecting, by the second RF receiver 420, the degradation of received Signal Strength, RSS, from the first receiver branch Rx1 connected to the first secondary antenna element A11, above the threshold degradation value, and in response to detecting the degradation of RSS from the first receiver branch Rx1 activating, by the second RF receiver 420, the second receiver branch Rx2 which is connected to the second secondary antenna element A22 adjacent to the first secondary antenna element A11.

The secondary wireless communications device 121 may be further configured to deactivate the first receiver branch Rx1 in response to activating the second receiver branch Rx2.

In some embodiments the secondary wireless communications device 121 is further configured to synchronize the secondary wireless communications device 121 in time with the primary wireless communications device 113 further based on the tuning 804 of the common frequency reference XO of the first RF receiver 410 and the second RF receiver 420.

The embodiments herein may also be implemented through a respective processing circuit 1004, 1104 e.g., comprising one or more processors, in the primary wireless communications device 113 and the secondary wireless communications device 121 depicted in FIG. 10 and FIG. 11 respectively, together with computer program code, e.g., computer program, for performing the functions and actions of the embodiments herein. The program code mentioned above may also be provided as a computer program product, for instance in the form of a data carrier carrying computer program code for performing the embodiments herein when being loaded into the primary wireless communications device 113 or the secondary wireless communications device 121. One such carrier may be in the form of a CD ROM disc. It is however feasible with other data carriers such as a memory stick. The computer program code may furthermore be provided as pure program code on a server and downloaded to the primary wireless communications device 113 and the secondary wireless communications device 121.

The primary wireless communications device 113 and the secondary wireless communications device 121 may further comprise a respective memory 1002, 1102 comprising one or more memory units. The memory 1002, 1102 comprises instructions executable by the respective processing circuit 1004, 1104 in the primary wireless communications device 113 and the secondary wireless communications device 121. The memory 1002, 1102 is arranged to be used to store e.g. information, indications, data, configurations, and applications to perform the methods herein when being executed in the primary wireless communications device 113 and the secondary wireless communications device 121. The memory 1002, 1102 may be a non-volatile memory e.g., comprising NAND gates, from which the primary wireless communications device 113 and the secondary wireless communications device 121 may load its program and relevant data. Updates of the software may be transferred via a wireless connection.

To perform the actions above, embodiments herein provide a respective computer program 1003, 1103. The computer program 1003, comprises computer readable code units which when executed on the primary wireless communications device 113 causes the primary wireless communications device 113 to perform the method according to FIG. 7.

The computer program 1103, comprises computer readable code units which when executed on the secondary wireless communications device 121 causes the secondary wireless communications device 121 to perform the method according to FIG. 8.

In some embodiments, the computer program 1003, 1103 comprises instructions, which when executed by a processor, such as the processing circuit 1004, 1104 of the primary wireless communications device 113 and the secondary wireless communications device 121, cause the processor to perform any of the method actions above.

In some embodiments, a respective carrier 1005, 1105 comprises the computer program 1003, 1103 wherein the carrier 1005, 1105 is one of an electronic signal, an optical signal, an electromagnetic signal, a magnetic signal, an electric signal, a radio signal, a microwave signal and a computer-readable storage medium.

To perform the method actions above, the primary wireless communications device 113 and the secondary wireless communications device 121 may comprise a respective Input and Output (I/O) unit 1006, 1106. The I/O unit 1006, 1106 may further be part of one or more user interfaces. The I/O units 1006, 1106 may comprise radio frequency (RF) communication equipment, such as RF transceivers.

Those skilled in the art will appreciate that the modules and/or units in the primary wireless communications device 113 and the secondary wireless communications device 121 described above may refer to a combination of analog and digital circuits, and/or one or more processors configured with software and/or firmware, e.g., stored in the primary wireless communications device 113 and the secondary wireless communications device 121, that when executed by, e.g., the processing circuit 1004, 1104 above causes the primary wireless communications device 113 and the secondary wireless communications device 121 to perform the method actions above. The processing circuit 1004, 1104 as well as the other digital hardware, may be included in a single Application-Specific Integrated Circuitry (ASIC), or several processors and various digital hardware may be distributed among several separate components, whether individually packaged or assembled into a system-on-a-chip (SoC).

As used herein, the term “module” and the term “unit” may refer to one or more functional modules or units, each of which may be implemented as one or more hardware modules and/or one or more software modules and/or a combined software/hardware module. In some examples, the module may represent a functional unit realized as software and/or hardware.

As used herein, the term “computer program carrier”, “program carrier”, or “carrier”, may refer to one of an electronic signal, an optical signal, a radio signal, and a computer readable medium. In some examples, the computer program carrier may exclude transitory, propagating signals, such as the electronic, optical and/or radio signal. Thus, in these examples, the computer program carrier may be a non-transitory carrier, such as a non-transitory computer readable medium.

As used herein, the term “processing module” may include one or more hardware modules, one or more software modules or a combination thereof. Any such module, be it a hardware, software or a combined hardware-software module, may be a cavity-providing means, electrical interconnect-providing means and arranging means or the like as disclosed herein. As an example, the expression “means” may be a module corresponding to the modules listed above in conjunction with the figures.

As used herein, the term “software module” may refer to a software application, a Dynamic Link Library (DLL), a software component, a software object, an object according to Component Object Model (COM), a software component, a software function, a software engine, an executable binary software file or the like.

The terms “processing module” or “processing circuit” may herein encompass a processing unit, comprising e.g. one or more processors, an Application Specific integrated Circuit (ASIC), a Field-Programmable Gate Array (FPGA) or the like. The processing circuit or the like may comprise one or more processor kernels.

As used herein, the expression “configured to/for” may mean that a processing circuit is configured to, such as adapted to or operative to, by means of software configuration and/or hardware configuration, perform one or more of the actions described herein.

As used herein, the term “action” may refer to an action, a step, an operation, a response, a reaction, an activity or the like. It shall be noted that an action herein may be split into two or more sub-actions as applicable. Moreover, also as applicable, it shall be noted that two or more of the actions described herein may be merged into a single action.

As used herein, the term “memory” may refer to a hard disk, a magnetic storage medium, a portable computer diskette or disc, flash memory, Random Access Memory (RAM) or the like. Furthermore, the term “memory” may refer to an internal register memory of a processor or the like.

As used herein, the term “computer readable medium” may be a Universal Serial Bus (USB) memory, a DVD-disc, a Blu-ray disc, a software module that is received as a stream of data, a Flash memory, a hard drive, a memory card, such as a MemoryStick, a Multimedia Card (MMC), Secure Digital (SD) card, etc. One or more of the aforementioned examples of computer readable medium may be provided as one or more computer program products.

As used herein, the term “computer readable code units” may be text of a computer program, parts of or an entire binary file representing a computer program in a compiled format or anything there between.

As used herein, the terms “number” and/or “value” may be any kind of number, such as binary, real, imaginary or rational number or the like. Moreover, “number” and/or “value” may be one or more characters, such as a letter or a string of letters. “Number” and/or “value” may also be represented by a string of bits, i.e. zeros and/or ones.

As used herein, the expression “in some embodiments” has been used to indicate that the features of the embodiment described may be combined with any other embodiment disclosed herein.

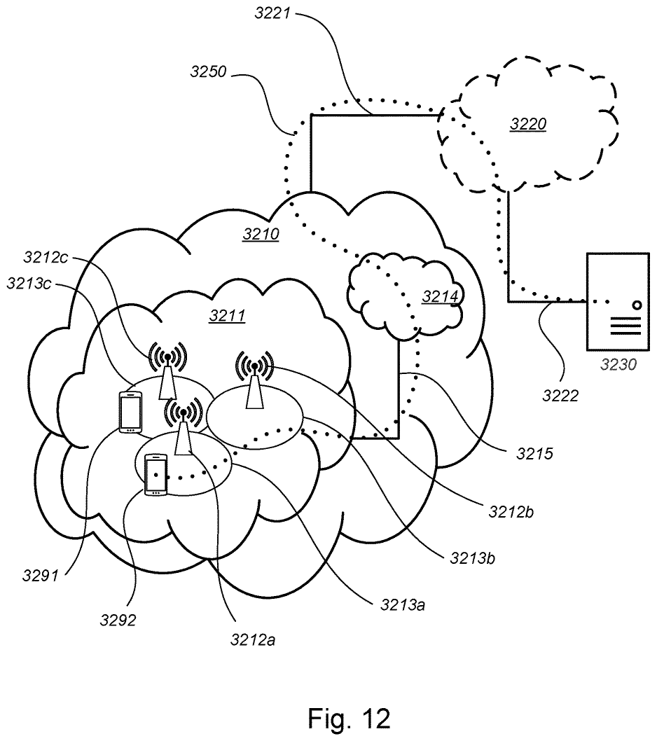

With reference to FIG. 12, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as the network nodes 111, 112, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as a Non-AP STA 3291 located in coverage area 3213c is configured to wirelessly connect to, or be paged by, the corresponding base station 3212c. A second UE 3292 such as a Non-AP STA in coverage area 3213a is wirelessly connectable to the corresponding base station 3212a. While a plurality of Ues 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 12 as a whole enables connectivity between one of the connected Ues 3291, 3292 such as e.g. the secondary wireless communications device 121, and the host computer 3230. The connectivity may be described as an over-the-top (OTT) connection 3250. The host computer 3230 and the connected Ues 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

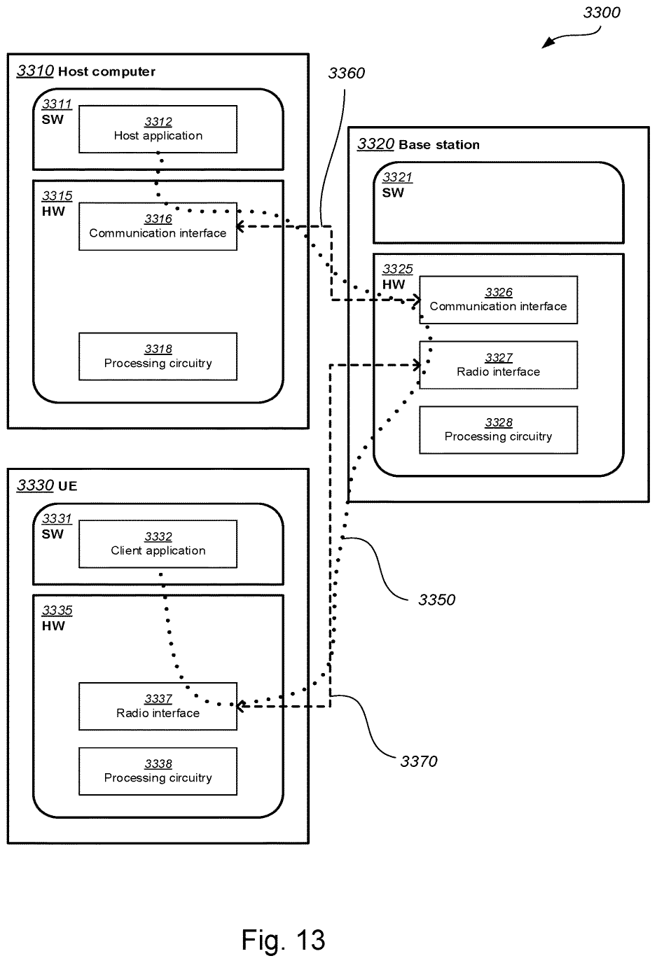

Example implementations, in accordance with an embodiment, of the UE, base station and host computer discussed in the preceding paragraphs will now be described with reference to FIG. 13. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 13) served by the base station 3320. The communication interface 3326 may be configured to facilitate a connection 3360 to the host computer 3310. The connection 3360 may be direct or it may pass through a core network (not shown in FIG. 13) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 13 may be identical to the host computer 3230, one of the base stations 3212a, 3212b, 3212c and one of the Ues 3291, 3292 of FIG. 12, respectively. This is to say, the inner workings of these entities may be as shown in FIG. 13 and independently, the surrounding network topology may be that of FIG. 12.

In FIG. 13, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the data rate, latency, power consumption and thereby provide benefits such as reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

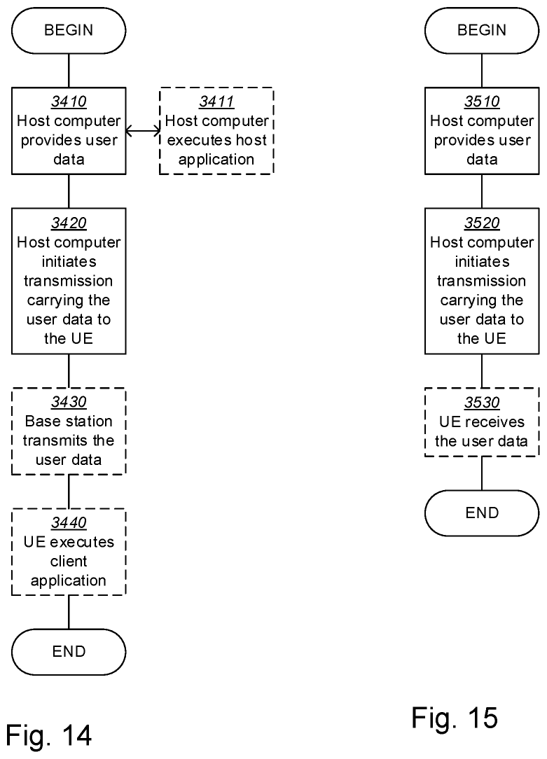

FIG. 14 is a flowchart illustrating a method implemented in a communication system, in accordance with one embodiment. The communication system includes a host computer, a base station such as an AP STA, and a UE such as a Non-AP STA which may be those described with reference to FIG. 12 and FIG. 13. For simplicity of the present disclosure, only drawing references to FIG. 12 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 15 is a flowchart illustrating a method implemented in a communication system, in accordance with one embodiment. The communication system includes a host computer, a base station such as an AP STA, and a UE such as a Non-AP STA which may be those described with reference to FIG. 12 and FIG. 13. For simplicity of the present disclosure, only drawing references to FIG. 13 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

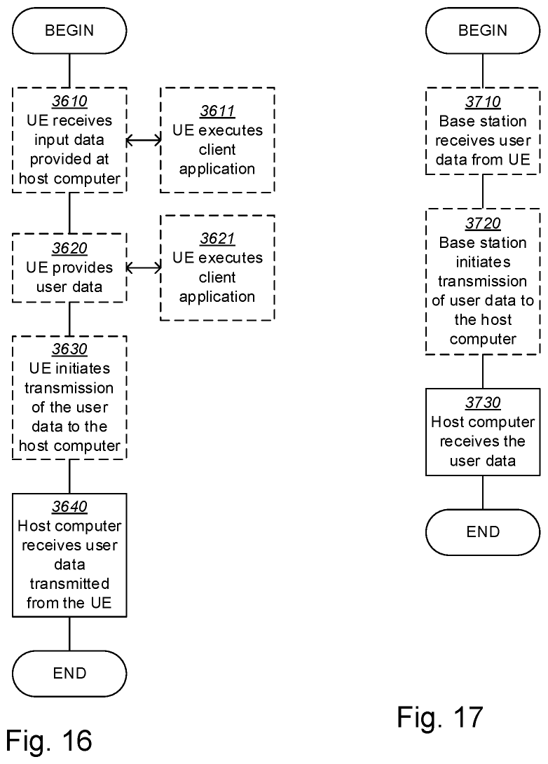

FIG. 16 is a flowchart illustrating a method implemented in a communication system, in accordance with one embodiment. The communication system includes a host computer, a base station such as an AP STA, and a UE such as a Non-AP STA which may be those described with reference to FIG. 12 and FIG. 13. For simplicity of the present disclosure, only drawing references to FIG. 14 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 17 is a flowchart illustrating a method implemented in a communication system, in accordance with one embodiment. The communication system includes a host computer, a base station such as an AP STA, and a UE such as a Non-AP STA which may be those described with reference to FIGS. 12 and 13. For simplicity of the present disclosure, only drawing references to FIG. 15 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

Even though embodiments of the various aspects have been described, many different alterations, modifications and the like thereof will become apparent for those skilled in the art. The described embodiments are therefore not intended to limit the scope of the present disclosure.

1.-25. (canceled)

26. A method performed by a primary wireless communications device for synchronization of Device-to-Device (D2D) wireless communication with a secondary wireless communications device, the method comprising:
broadcasting, on a D2D wireless communications channel, a single-tone synchronization signal for synchronization of the secondary wireless communications device to the primary wireless communications device, wherein broadcasting the single-tone synchronization signal comprises modulating the single-tone synchronization signal with a data sequence.

27. The method according to claim 26, wherein modulating the single-tone synchronization signal with the data sequence comprises modulating an amplitude of the single-tone synchronization signal with the data sequence.

28. The method according to claim 26, wherein the data sequence indicates one or more of the following:
a transmit beam of the primary wireless communications device used for the synchronization signal,
an identity of the primary wireless communications device,
a reference sequence known to the secondary wireless communications device, and
a time stamp.

29. The method according to claim 26, wherein the single-tone synchronization signal is broadcasted using a gap band in one of the following:
a frequency spectrum of the D2D wireless communications channel, or
a frequency spectrum of a communications link between the primary wireless communications device and a radio access node.

30. The method according to claim 26, wherein a bitrate of the data sequence is based on to a required precision of the synchronization of the secondary wireless communications device to the primary wireless communications device

31. The method according to claim 26, wherein the data sequence comprises a first low bit rate sequence and a second high bit rate sequence.

32. The method according to claim 26, further comprising reporting, to a network node of a wireless communications network in which the primary wireless communications device and the secondary wireless communications device operate, the primary wireless communications device's capability of transmitting the single-tone synchronization signal.

33. A method performed by a secondary wireless communications device for synchronization of Device-to-Device (D2D) wireless communication with a primary wireless communications device, wherein the secondary wireless communications device comprising a first Radio Frequency (RF) receiver for wireless communication with the primary wireless communications device and a second RF receiver operating at a reduced energy consumption relative to the first RF receiver, the method comprises:
receiving, with the second RF receiver via a D2D wireless communications channel, a single-tone synchronization signal for synchronization of the secondary wireless communications device to the primary wireless communications device, wherein the single-tone synchronization signal is modulated with a data sequence;
tuning a common reference oscillator (XO) of the first RF receiver and the second RF receiver using a frequency difference between a carrier frequency of the single-tone synchronization signal and a Local Oscillator (LO) frequency of the second RF receiver, such that the frequency difference obtains a target value;
synchronizing the secondary wireless communications device in time with the primary wireless communications device based on the second RF receiver correlating the modulating data sequence with a reference data sequence in a time domain; and
communicating, by the first RF receiver based on the tuned XO and the synchronization in time, control signals and/or data signals via the D2D wireless communications channel with the primary wireless communications device.

34. The method according to claim 33, wherein the data sequence indicates one or more of the following:
a transmit beam of the primary wireless communications device used for the synchronization signal,
an identity of the primary wireless communications device,
a reference sequence known to the secondary wireless communications device, and
a time stamp.

35. The method according to claim 33, wherein the carrier frequency of the single-tone synchronization signal is determined based on tuning a frequency of the XO until the modulating data sequence is found when demodulating the single-tone synchronization signal.

36. The method according to claim 33, wherein the carrier frequency of the single-tone synchronization signal is determined based on applying Intermediate Frequency (IF), filters centred at different frequencies and identifying which of the IF filters outputs the synchronization signal with highest signal strength.

37. The method according to claim 33, wherein:
the data sequence modulating the single-tone synchronization signal comprises a first data sequence and a second data sequence with a higher bit rate than the first data sequence;
the reference data sequence comprises first and second reference data sequences; and
correlating the modulating data sequence with the reference data sequence in a time domain comprises:
determining a rough time synchronization based on correlating the first data sequence modulating the single-tone synchronization signal with the first reference data sequence; and
determining a fine time synchronization based on correlating, over a time interval derived from the rough time synchronization, the second data sequence modulating the single-tone synchronization signal with the second reference data sequence.

38. The method according to claim 33, wherein:
the second RF receiver is equipped with multiple receiver branches; and
the single-tone synchronization signal is received by sequentially receiving the single-tone synchronization signal with one of the following:
different single receiver branches of the multiple receiver branches or
different combinations of the multiple receiver branches.

39. The method according to claim 38, further comprising determining a receive direction of the single-tone synchronization signal based on one or more of the following:
estimating an angle of arrival based on a detected coincidence of a radiation null formed by a combination of the multiple receiver branches and the received single-tone synchronization signal during null sweeping with the second RF receiver; and
comparing a first phase of a first correlation peak from a first one of the multiple receiver branches with a second phase of a second correlation peak from a second one of the multiple receiver branches.

40. The method according to claim 38, wherein receiving the single-tone synchronization signal comprises:
detecting, by the second RF receiver, a degradation of received Signal Strength (RSS) from a first one of the multiple receiver branches, wherein the first receiver branch is connected to a first secondary antenna element, wherein the detected degradation is above a threshold degradation value; and
in response to detecting the degradation of RSS from the first receiver branch, activating, by the second RF receiver, a second one of the multiple receiver branches, wherein the second receiver branch is connected to a second secondary antenna element adjacent to the first secondary antenna element.

41. The method according to claim 40 further comprising deactivating the first receiver branch in response to activating the second receiver branch.

42. The method according to claim 33, wherein synchronizing the secondary wireless communications device in time with the primary wireless communications device is further based on the tuning of the XO.

43. A primary wireless communications device configured for synchronization of Device-to-Device (D2D) wireless communication with a secondary wireless communications device, the primary wireless communication device comprising:
a radio frequency (RF) transceiver configured for D2D wireless communication with the secondary wireless communications device; and
processing circuitry operably coupled to the RF transceiver, wherein the processing circuitry and the RF transceiver are configured to perform the method of claim 26.

44. A secondary wireless communications device configured for synchronization of Device-to-Device (D2D) wireless communication with a primary wireless communications device, wherein the secondary wireless communications device comprises:
a first Radio Frequency (RF) receiver for wireless communication with the primary wireless communications device;
a second RF receiver operating at a reduced energy consumption relative to the first RF receiver; and
processing circuitry operably coupled to the first and second RF receivers, wherein the processing circuitry and the first and second RF receivers are configured to:
receive, with the second RF receiver via a D2D wireless communications channel, a single-tone synchronization signal for synchronization of the secondary wireless communications device to the primary wireless communications device, wherein the single-tone synchronization signal is modulated with a data sequence;
tune a common reference oscillator (XO) of the first RF receiver and the second RF receiver using a frequency difference between a carrier frequency of the single-tone synchronization signal and a Local Oscillator (LO) frequency of the second RF receiver, such that the frequency difference obtains a target value;
synchronize the secondary wireless communications device in time with the primary wireless communications device based on the second RF receiver correlating the modulating data sequence with a reference data sequence in a time domain; and
communicate, by the first RF receiver based on the tuned XO and the synchronization in time, control signals and/or data signals via the D2D wireless communications channel with the primary wireless communications device.
